(19) United States
(12) Patent Application Publication
(10) Pub. No.: US 2015/0230445 A1
(43) Pub. Date: Aug. 20, 2015

(54) DEVICE FOR FISHING OBJECT EJECTION

(71) Applicant: Arwe Fotland, Vinterbro (NO)

(72) Inventor: Arwe Fotland, Vinterbro (NO)

(21) Appl. No.: 14/415,883

(22) PCT Filed: Jul. 20, 2012
(86) PCT No.: PCT/NO2012/050139

§ 371 Date: Jan. 27, 2015

(51) Int. Cl. A01K 91/02; F41B 11/73; F41B 11/60; F41B 11/80; A01K 99/00; A01K 97/00

(52) U.S. Cl. CPC A01K 91/02; A01K 99/00; A01K 97/00; F41B 11/60; F41B 11/80; F41B 11/73

(57) ABSTRACT

Device for ejection of a fishing object is presented, comprising a launch tube (21), a fishing object (22) adapted to be placed in the launch tube (21) and an energy source (2) for creating a fluid pressure in the launch tube (21) and thereby ejecting the fishing object through the launch tube (21), where the fishing object is equipped with a sealing cross-section (23.25) for sealing against launch tube.

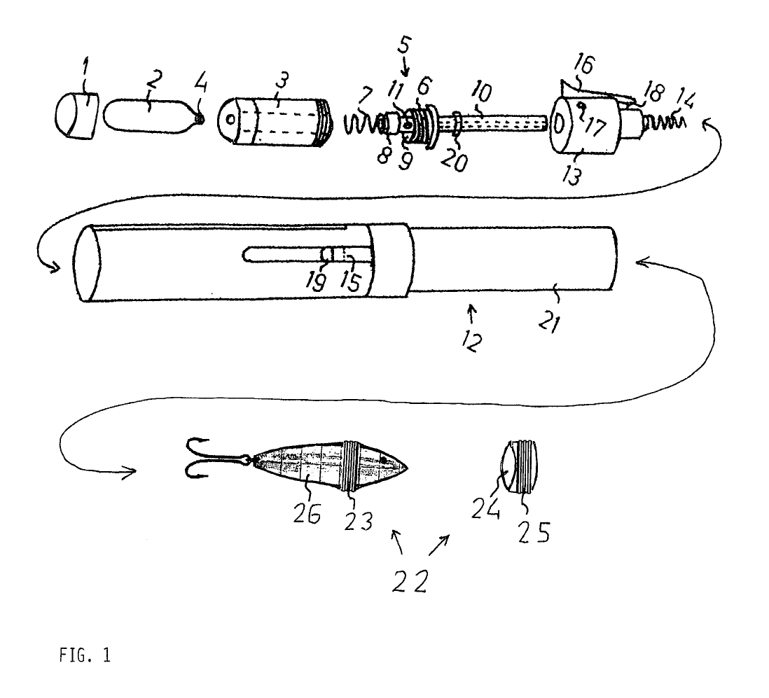

### FIELD OF THE INVENTION

The present invention relates to a device for ejection of a fishing object, comprising a launch tube, a fishing object placed in the launch tube and an energy source that is designed to create a fluid pressure in the launch tube and thereby ejecting the fishing object throughout the launch tube.

### BACKGROUND OF THE INVENTION

It is already known from Norwegian patent application 20050314 a device for launching a fishing equipment. It is here described a device for gas-driven ejection of fishing gear such as hooks, lures, spinners, floats, weights and flies by a device for the provision of compressed gas to a gas-bearing chamber part and which has been connected with a launch tube, where the arrangement for the provision of compressed gas is connected to a trigger mechanism that activates the gas supply to the launch tube, and where in the launch tube is placed a plug or similar device, thrown out with the fishing gear by means of the supply of compressed gas to the launch tube. This arrangement describes the ejection of traditional fishing equipment and therefore has no description of a new fish object. It also has the disadvantage that it has no defined seal and thus the accompanying pressure loss. In addition, the fishing gear can be inappropriately placed.

An ejection mechanism for fishing gear is disclosed in the U.S. Pat. No. 3,962,813.which presents an ejection telescopic fishing rod mechanism where the rod is ejected with the hook and bait. This is an energetic little suitable method with very limited use of fishing objects.

Furthermore, from U.S. Pat. No. 3,828,459 a gas driven device where the bait and the hook is in a cradle, and the cradle is launched by mechanical influence of a gas-driven piston is known. The cradle is placed on top of a long pole, which is a cumbersome and space absorbing design. In addition, the mechanical impact system that is gas powered represents a poor utilization of the energy of the ejection mechanism.

Also U.S. Pat. No. 3,717,947 presents a gas powered ejection device for fishing equipment, but here it is required that the fishing line is placed in the ejection mechanism, which would be cumbersome and impractical, since the line and the hook can be cut since it hangs on the outside of the device and thereby also in addition represents a safety hazard.

### SUMMARY OF THE INVENTION

There is thus a need for a fishing object with a seal for optimum energy utilization and having a combination of weight and profile that increases range and accuracy as well as an ejection mechanism that is short, having a low weight so that the device is no burden for fishing and operation of the other fishing equipment and for a device that avoids the disadvantages of previously known devices. This is achieved by a device according to claim 1.

The fishing object can be represented by any number of different shapes and sizes but common to them is that they have a sealing cross-section which may be circular non-circular, or have any shape as long as the launch tube have the same shape. The tubes do not necessarily mean that is a circular cross-section but a cross section of any shape. It could, for example, have a cross sectional shape as a wing profile to mention one possible cross section shape.

The energy source can be any energy source that is likely to create a fluid pressure in the launch tube. Fluid pressure can be a gas pressure or liquid pressure. In addition, the fishing object could be of such a nature that it would introduce lift and/or have a shape that reduces drag which will also increase the range and accuracy while providing properties under water making it suitable as a fishing object.

The fishing object can be designed as a continuous or broken body with any cross-sectional profile.

Alternatively, the fishing object can comprise a piston with a sealing cross-section and the fishing tool in the back/front.

By adding a natural biodegradable custom piston at the back/front of other fishing tools such as hooks, lures, spinners, floats, weights, flies, etc., the tool may also be ejected.

### BRIEF DESCRIPTION OF THE FIGURES

The accompanying FIGURE shows an exploded drawing of the composition of one design form of a fishing object ejection device according to the invention.

### DESCRIPTION OF EMBODIMENTS OF THE INVENTION

Referring to the FIGURE the ejector device comprises a gas cartridge/tank (fixed or removable) (2) which by the use of threads (4) or similar puncture and fill the valve body (3) with gas under pressure equivalent to the gas pressure in the gas cartridge/tank (fixed or removable) (2) and is covered with a end cap (1) the main cover (12).

To the valve body (3) upper end there is attached a valve (5). The valve (5) comprises of a valve retainer (6) which is screwed gas-tight into the valve body (3). In the center of the valve body (3) a spring (7) pushes the valve seal (8) into a valve seat (9) in the valve retainer (6). When the ejection mechanism according to the invention is not in the active position, the valve seal (8) will be gas-tight against the valve seat (9).

To the valve seal (8) there is attached a valve stem (10) which in its lower end is provided with at least one gas transfer hole (11). When the ejection mechanism is not in the active position, the hole (11) will not be available for gas flow since the valve seal (8) is positioned in the valve seat (9) and thus will prevent gas from penetrating past the valve seal (8) and the valve seat (9).

When the ejection mechanism according to the invention is in the active position, the valve seat (9) and the valve seal (8)) will be apart and the gas flow hole (11) will then be open for the passage of gas to the main cover (12). The gas will pass through the valve stem (10), which is hollow through hole (11).

To measure the correct amount of gas to be supplied to the main cover (12), the ejection device according to the invention will be equipped with a trigger mechanism. The trigger mechanism according to the design form shown in the FIGURE consists of a hammer body (13) which is charged by a spring (14). The spring (14) is charged by an extension through the slots in the main cover (12) to a movable handle which enables the compression and hence the charging of the spring (14). The hammer body (13) fits and can slide inside the main cover (12) so that the spring (14) rests against an inner edge (15) in the main cover (12). The trigger mechanism consists of the hammer body (13) and an associated hammer trigger (16) that is placed in a groove in the hammer body (13). As a safety feature against unwanted activation of the trigger mechanism according to the invention, it is preferred to place a safety pin (17) on the hammer body (13) to block the hammer trigger (16). Alternatively, as a safety feature against unwanted activation of the trigger mechanism according to the invention, a spring is assembled in the safety pin (17) on the hammer body (13) so that the hammer trigger can not be released without an active two-handed grip.

At the rear of the hammer trigger (16) there is a hook (18) which will engage with an edge (19) located in the main cover (12). When the ejection device according to the invention is charged the hook (18) prevents the hammer body (13) from moving in the main cover (12). When the hammer trigger (16) is operated, after the safety pin (17) is released, the spring (14) will shoot the hammer body (13) towards a defined edge (20) on the valve stem (10). The valve stern (10), which is movable in the valve retainer (6), will then briefly be pushed down to release the hole (11) and thus get access to the valve body (3) and its pressurized space. The gas in the valve body (3) will freely flow out to the launch tube (21) in the main cover (12). Launch tube (21) is in the bottom fitted with a hole (not shown) so that gas is continued from the upper end of the valve stem (10).

Referring to the FIGURE the fishing object (22) can comprise a full or a divided body (26) holding a sealing cross-section (23). Alternatively, the fishing object can comprise a natural degradable piston (24) with an associated sealing cross-section (25). The sealing cross-section can either consist of a defined one step gap or as a set of gaps that make up a labyrinth seal, or be another form of approximately non leaking and low friction dynamic seal. The body (26), alternatively the piston (24), that is designed for example as a disk, a half sphere or a ball holds a sealing cross-section to essentially create as a narrow gap in the launch tube (21) as possible.

In the bottom of the launch tube (21) the body (26), alternatively a piston (24), is placed with the fishing tool located in the rear/front and thereby accelerate out of the end of the launch tube(21) when the hammer trigger (16) is operated. The fishing tool may comprise of such as hooks, lures, spinners, floats, weights and flies.

The alternative piston (24) is preferably made of a material that is not harmful to the environment or polluting, and is biodegradable by nature. Examples of such materials are cellulose, rubber, a sugar polymer, potato starch or other biodegradable plastics preferably or cellulose derivative.

It may also be appropriate to make the alternative piston (24) of an appropriate material, for example a material that also can dissolve in water. In some cases, such as the launch of lighter hooks and or hooks with large air resistance, such as fishing flies or spinners, it may be necessary to attach the hook to the piston (24) so that the piston (24) travels with the hook. When the piston (24) hits the water, it will then subsequently dissolve, and the hook will be placed in a location that is far from the launch site. It is particularly preferred to design the piston (24) in this way when launching fishing flies.

The sealing cross-section can, as mentioned earlier, be either one or a set of gaps, or another form of approximately non leaking and low friction dynamic seal. With respect to the gaps may be designed so that a narrow gap is followed by a marginally wider gap. When the leaking fluid is passing through the narrow gap and getting into the area of the wider gap it will create an area of local turbulence and hence this will be blocking for the leaking fluid. The sealing cross-section might be cast as an integral part of the fishing object (22) or as a partially embedded element. In addition, the sealing cross-section can include a groove in the fishing object in which a lip seal, an o-ring or a similar low friction dynamic seal may be placed. It is reasonable to assume that lower leakage hence will increase friction and vice versa so there will exist an optimal relationship. It may also be possible to shrink or glue or use similar methods to get the appropriate seal tight. It is also possible to attach the appropriate seal with barbs over an edge or put it loosely into a slot or otherwise fastened it so that it would also be able to move under water.

The mechanism according to the invention is described above with reference to one possible embodiment. However, it will be possible to arrange the device with alternative parts without departing from the inventive concept.

Thus it will be possible to bring gas under pressure by equipping the device with a pump mechanism for a gas piston instead of a gas cartridge, or a mechanical preload triggered.

It may also be an option where a permanent piston (24) is operated and accelerated to a stop at for example a tapered edge to the end of the launch tube (21) when the trigger (16) is operated.

Another option would be to equip the ejection mechanism with an external gas tank to increase the number of possible launchings.

A possible alternative is to use a combustible gas such as propane or another explosive substance, which expands in a separate chamber that drives a piston that creates the ejection force.

A fluid pressure can also be used instead of a gas pressure.

Adaptation of such applications will be obvious to someone skilled in the art and thus to remain within the scope of the subject matter of the present invention.

Other options that will also be within the subject matter of the invention will be designing the individual joints with quick couplings, such as the hook type, rather than threads. With the use of such connections it will of course be advantageous to equip the individual joints with gaskets made for non leakage.

It would also be possible to equip the device according to the invention with springs of optional stiffness, if necessary, to adjust the tension of these springs to adjust the amount of gas released during each activation of the ejection device of the invention.

Other options for the device, according to the invention, is to customize the size. Using the ejection mechanism according to the invention for fishing in a lake, where there is no need for such large fish hooks or where it is necessary to facilitate small hooks, such as spinners or fishing flies, the ejection mechanism can be adapted to this use by changing the dimensions and spring tension as necessary. Such adaptation, however, is obvious for some skilled in the art on the basis of the above description.

With respect to materials, it is preferred, but not limited to materials such as composites, such as Kevlar or carbon fiber reinforced fiberglass, metals such as alloy, such as aluminum or aluminum alloys, plastic materials such as hard plastic or other materials that are lightweight and sufficiently rigid to withstand the current fluid pressure.

In an embodiment the ejection mechanism according to the invention is a full or partial integral part of the fishing rod. Adaptation of such full or partial integrated device will be obvious to someone skilled in the art, and will be within the scope of the subjected matter of the present invention.

1. A device for ejection of a fishing object, comprising:
a launch tube;
a fishing object adapted to be placed in the launch tube; and
means for accelerating the fishing object in the launch tube, wherein the fishing object comprises a sealing cross-section adapted to seal against the launch tube and comprising at least one of: a set of gaps forming a labyrinth seal, a contact sealing surface of a material which is adapted to reduce leakage and friction, a dynamic seal adapted to reduce leakage and friction, a lip seal adapted to reduce leakage and friction using fluid pressure.

2. The device according to claim 1, wherein the fishing object is a continuous body.

3. The device according to claim 1, wherein the fishing object is a broken body.

4. The device according to claim 1, wherein the fishing object comprises a piston with a sealing cross-section and a fishing tool in the rear/front.

5. The device according to claim 1, wherein the fishing object comprises one or more of: a composite material, a hard plastic, a soft plastic, and a light metal.

6. The device according to claim 1, wherein the fishing object is made entirely or partly of biodegradable material.

7. The device according to claim 1, wherein the fishing object has a shape that provides aerodynamic lift, and/or a cross section that reduces drag, and/or a surface that reduces friction.

8. The device according to claim 1, wherein the means for accelerating the fishing object comprises an arrangement for the provision of compressed gas to a gas-bearing valve body adapted to be connected to the launch tube, wherein the arrangement for the provision of compressed gas is connected to a hammer trigger that is adapted to activate a supply of compressed gas to the launch tube for accelerating the fishing object out of the launch tube by means of the supply of compressed gas in the launch tube.
